(19) United States
(12) Patent Application Publication
(10) Pub. No.: US 2006/0053013 A1
(43) Pub. Date: Mar. 9, 2006

(54) Selection of a user language on purely acoustically controlled telephone

(76) Inventors: Roland Aubauer, Munchen (DE); Erich Kamperschroer, Hamminkein (DE); Stefan Amnbrosius Klinke, Kerpen (DE); Niels Kunstmann, Haar (DE); Karl-Heinz Pflaum, Bocholt (DE)

Correspondence Address: STAAS & HALSEY LLP, SUITE 700, 1201 NEW YORK AVENUE, N.W., WASHINGTON, DC, 20005, US

(21) Appl. No.: 10/537,486

(22) PCT Filed: Nov. 24, 2003
(86) PCT No.: PCT/EP03/13182

§ 371 Date: Jun. 3, 2005

(30) Foreign Application Priority Data
Dec. 5, 2002 (DE) 102 56 935.5

(51) Int. Cl. G10L 15/14

(52) U.S. Cl. 704/256

(57) ABSTRACT

The user language of a device can be set to a user language by speaking the designation of the user language to be set.

### CROSS REFERENCE TO RELATED APPLICATIONS

This application is based on and hereby claims priority to German Application No. 10256935.5 filed on Dec. 5, 2002, the contents of which are hereby incorporated by reference.

### BACKGROUND OF THE INVENTION

In communication and information equipment, text information is displayed in the language specified by the country version. Accompanying this, there is the facility for the user to set the language required as the user language or operator language. If—for whatever reason—the language of the user interface is now altered, the user faces the problem of resetting the user language required without the option of being guided to the relevant menu entry or control status by feedback in text form.

This problem is a general one and is not restricted to graphical user interfaces with keyboard or mouse input. On the contrary, there will in future be more and more terminal devices which are operated purely acoustically. The problem is also faced at call centers which are operated purely acoustically. Here, speech input is effected via speech recognition and speech output either through the playing of preproduced speech recordings or through automated speech synthesis in the form of a text-to-speech conversion.

In devices with a screen input or display input and keyboard input, the following procedure is found for solving the problem shown: in general, there is the facility for resetting the device to the factory language setting. This is usually carried out by a defined key combination. There are also devices in which a language menu can be activated in a simple manner, the user being able to select the target language. This then looks approximately as follows:

TABLE 1

Deutsch
Français
English

[symbol]

(Ukrainian)
Românesc
(Romanian)
.
.
.

In this menu, the user can now select the required user language to be set. Such a procedure is of course not possible for purely acoustically controlled devices.

### SUMMARY OF THE INVENTION

From this starting point, an object of the invention is to enable the selection of the user language of a device by a purely acoustic method. The selection facility is also designed to be available in particular in cases where the device cannot, or is not intended to, provide assistance through a display.

The user language to be set for a device can easily be set, simply by speaking the user language to be set in order to select the user language. An English person therefore says “English”, a German person simply says “Deutsch”, a Frenchman says “Français” and a Ukrainian says “Ukrajins'kyj” (English transliteration of “Ukrainian” in Polish script).

The implementation of this functionality in the speech recognition unit of the device is no trivial matter, which is why preferred options will be described in greater detail below.

One option is training a single-word recognizer to recognize the designations of the user languages which can be set. Since the algorithms used here are chiefly based on a simple pattern comparison, a sufficient number of speech recordings in which the speech of mother-tongue speakers is recorded in relation to the relevant language is needed for the training. A dynamic-time-warp (DTW) recognizer, in particular, can be used for this.

If the device should already have phoneme-based speech recognition, for example for other functionalities, then it is advantageous to employ this for setting the user interface language. There are three options for doing this.

For example, a multilingual Hidden Markov Model (HMM) which models the phonemes of all the languages can be used in the speech recognition unit. A standardized representation of a phonetic alphabet, for example in the form of SAMPA phonemes, is particularly advantageous for this purpose.

As convincing as this approach is for the problem definition outlined, multilingual speech recognition techniques have in practice shown themselves to be inferior to language-specific modeling in terms of their recognition rate. A further acoustic model, which would use up further memory space, would therefore be needed for normal speech recognition in the device.

A different option, in which the phoneme sequences from the HMMs, which phoneme sequences are associated with the designations of the user languages to be set, are combined for the different languages, therefore proves to be advantageous. It must, however, be borne in mind here that the degrees of match which the speech recognition system delivers for the words modeled in different phoneme inventories are not directly comparable with one another. This problem can be circumvented if, in the combined HMM, the degrees of match for the phoneme sequences from the different recognizable user languages are scaled.

A particularly clever option is produced if, instead of one multilingual HMM or the combination of phoneme sequences of several language-specific HMMs, only one single language-specific or country-specific HMM is used and at the same time the designations of the foreign user languages are modeled using the language-specific phoneme set. The example below for German, which is based on the menu in Table 1, serves as an explanation of this. The word models are in “phonetic” orthography:

TABLE 2

/ d eu t sh /
/ f r o ng s ae /
/i ng l i sh /
/u k r ai n sk i j /
/ r o m a n e sh t sh /

Here, the need to use a multilingual HMM or to combine phoneme sequences having different phoneme inventories in the recognition process does not apply.

In accordance with the introductory definition of the problem, the device is in particular a mobile terminal in the form of a mobile or cordless telephone, a headset or the server of a call center.

Preferred embodiments of the method according to the invention will emerge in the same way as the preferred embodiments of the inventive device shown.

### BRIEF DESCRIPTION OF THE DRAWINGS

These and other objects and advantages of the present invention will become more apparent and more readily appreciated from the following description of an embodiment, taken in conjunction with the accompanying drawing of which:

FIG. 1 is a flowchart of the procedure for setting the user language.

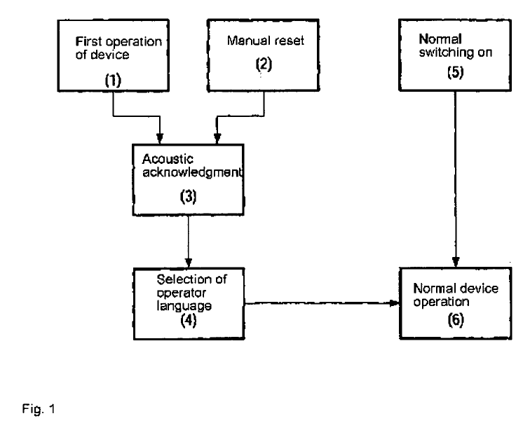

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The device can be implemented in the form of a cordless headset which is controlled exclusively via speech. This may for example be a headset which establishes, with or without cable, a connection to a base via Bluetooth, Dect, GSM, UMTS, GAP or another transmission standard.

The headset has an on/off button and a so-called “P2T” (push-to-talk) button, by which the audio channel is switched for a defined time window to speech recognition unit. The command control of the headset includes the brief pressing of the P2T button, an acknowledgment of the pressing of the button by a short beep and the subsequent speaking of the required command, to which the device responds accordingly.

When the device is first switched on (step 1) or after resetting of the device (step 2), which is caused, for example, by holding down the P2T button for a longer period, the user initially finds him-/herself at the user-language selection stage. This is communicated to the user by an acoustic signal (step 3), for example, a longer beep or a multilingual request to speak the user language to be set.

The user then speaks into the device, in the language to be set, the designation of the language to be set (step 4). The speech recognition unit of the device then recognizes the designation of the user language to be set spoken in the user language to be set, provided that the user language to be set is one of the several user languages settable for the device. The user language setting unit of the device then sets the user language of the device to the user language recognized by the speech recognition unit, as a result of which the device is initialized appropriately. The device can then be operated (step 6) as if it had been switched on normally (step 5).

Tried and tested means and methods from the prior art can be used to correct speech recognition and operating errors.

All the embodiments of the invention share the outstanding advantage that they significantly simplify and speed up operation of the device. Furthermore, where phoneme-based recognition is used, there is no need for speech recordings to be stored in the device. Optimal use is made here of the fact that phoneme-based acoustic resources are already present in the device.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. A device, comprising:
a speech recognition unit recognizing a designation of a user language of the device to be set, from among designations of settable user languages of the device that can be recognized by said speech recognition unit, each designation of each settable user language being in the settable user language; and
a language setting unit setting a user interface language of the device to the user language recognized by said speech recognition unit.

12. A device according to claim 11, wherein said speech recognition unit has a single-word recognizer.

13. A device according to claim 11, wherein said speech recognition unit has a phoneme-based recognizer.

14. A device according to claim 13, wherein said speech recognition unit uses a multilingual Hidden Markov Model.

15. A device according to claim 13, wherein said speech recognition unit uses a combined Hidden Markov Model which contains phoneme sequences from the settable user languages.

16. A device according to claim 15, wherein in the combined Hidden Markov Model, degrees of match for phoneme sequences from the settable user languages are scaled.

17. A device according to claim 13, wherein said speech recognition unit uses a language-specific Hidden Markov Model, having a language-specific phoneme set, in which the phonemes for the designations of the settable user languages are modeled using the language-specific phoneme set of the language-specific Hidden Markov Model.

18. A device according to claim 11, wherein the device is a mobile terminal.

19. A device according to claim 11, further comprising an output unit outputting a request to speak the designation of the user language to be set.

20. A method for setting a user language of a device, comprising:
recognizing, by speech recognition in the device, a designation of a user language spoken in the user language from among designations of settable user languages that can be recognized in the settable user languages by the device; and
setting the user language, obtained by said recognizing, as a user interface language of the device.

21. A device according to claim 11, wherein the device is a mobile terminal.

22. A device according to claim 11, further comprising an output unit outputting a request to speak the designation of the user language to be set.
